(19) United States
(12) Patent Application Publication
(10) Pub. No.: US 2012/0018536 A1
(43) Pub. Date: Jan. 26, 2012

(54) AIR DUSTER GUN

(76) Inventor: Jen-Chih CHANG, Taichung City (TW)

(21) Appl. No.: 13/158,908

(22) Filed: Jun. 13, 2011

(30) Foreign Application Priority Data
Jul. 23, 2010 (TW) 099214139

(51) Int. Cl. B05B 7/30

(52) U.S. Cl. 239/345

(57) ABSTRACT

An improved air inlet structure of an air duster gun comprises a main body, a pressing handle, and an air valve. The main body comprises a channel, and the channel comprises an air inlet and an air outlet at both ends of the channel respectively. The air valve is disposed in the main body and controlled by the pressing handle to open and close the channel. A connection unit is disposed at an end of the inlet of the main body. A metal ring snares the peripheral of the connection unit to strengthen the structure when an air joint is secured. The present invention is provided by means of the above.

### BACKGROUND OF THE INVENTION

1. Field of the Invention

The present invention relates to an air duster gun, especially to an improved air inlet structure of an air duster gun.

2. Description of the Related Art

With reference to FIG. 5 for a conventional air duster gun, the air duster gun comprises an air inlet 91 formed at a back end of a main body 9. The main body 9 comprises an air joint secured in the air inlet 91, and the air joint is connected to an air source of an air compressor through a pipe. As shown in FIG. 6, the mina body 9 comprises a recess 92 in the air inlet 91, and a metal adapter ring 93 disposed in the recess 92. The air joint is secured in the adapter ring 93. High-pressure air flows from the main body 9 to the air inlet 91 through the pipe and air joint. A pressing handle 94 disposed at a side of the main body 9 is pressed to cause an air valve work (not shown) so that the high-pressure air outputs from the air outlet 95 in the front end of the body 9.

In addition, the aforementioned adapter ring 93 comprises an engaging structure 931 in the peripheral. When the adapter ring 93 is placed in the recess 92, the engaging structure 931 in the peripheral is used to interlock with the internal wall of the recess 92 for a secured connection. However, the adapter ring 93 needs to include the engaging structure 931, thus incurring a higher manufacturing cost of the components and a difficult manufacturing process. It is a main problem for the present invention to resolve.

### SUMMARY OF THE INVENTION

The purpose of the present invention is to resolve the problem mentioned above by providing an improved air inlet structure of an air duster gun. The structure of one end of the air inlet of the main body secured by the air joint is strengthened. Besides, it can avoid an end of the air joint of the main body from being cracked when the air joint is secured, thus incurring a less cost for the strengthened structure and is an easier assembling process.

To achieve the above purpose, the present invention comprises a main body, including a channel for flowing high-pressure air, an air outlet at the front end of the channel and an air inlet at the back end of the channel, and an air valve, and a pressing handle for controlling the air valve, which can resume its original position after pressed, being pivotally disposed at a side of the main body, characterized in that the main body comprises a connection unit for securing the air joint at one end of the air inlet, and the connection unit extends outwards from the end of the air inlet of the main body, wherein a metal ring snares a peripheral of the connection unit so that the air joint is snared by the metal ring when the air joint is snared by the peripheral of the connection unit.

### BRIEF DESCRIPTION OF THE DRAWINGS

FIG. 1 is a perspective view of the air duster gun of the present invention;

FIG. 2 is a structural view of the metal ring snaring the connection unit of the present invention;

FIG. 3 is a cross-sectional view of the metal ring snaring the connection unit of the present invention;

FIG. 4 is a diagram of the air joint combined with the connection unit of the present invention;

FIG. 5 is a perspective view of the conventional air duster gun;

FIG. 6 is a schematic view of the main body and adapter ring of a conventional air duster gun.

### DETAILED DESCRIPTION OF THE PREFERRED EMBODIMENTS

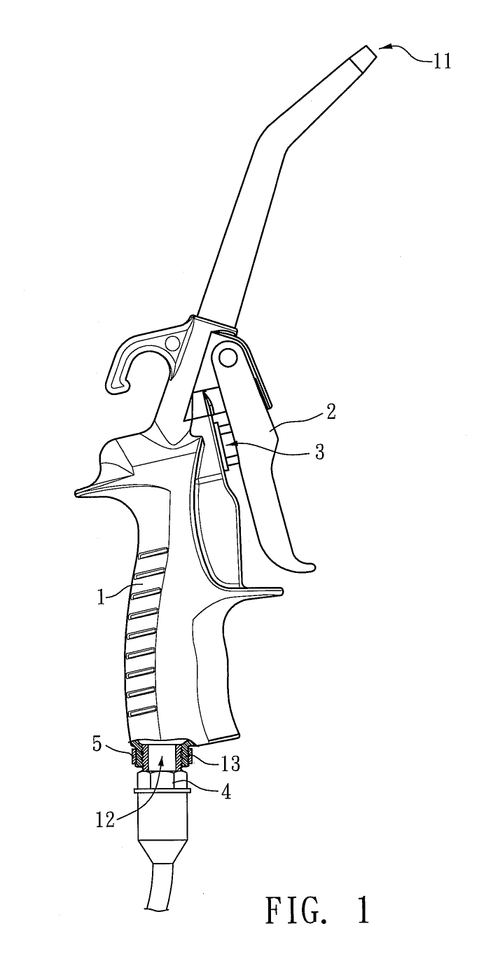

With reference to FIGS. 1 to 4 for an embodiment of the present invention, the embodiment is provided for the explanation purpose, but not for limiting the structure of the present invention.

The present invention provides an improved air inlet structure of an air duster gun, as shown in FIG. 1, comprising a main body 1, a pressing handle 2, an air valve 3.

The main body 1 comprises a channel (not shown), and the high-pressure air can flow in the channel. The main body 1 comprises an air inlet 11 at the front end of the channel, and an air outlet 12 at the back end of the channel.

The pressing handle is disposed on a side of the main body 1, and a return spring (not shown) is disposed between the main body 1 and the pressing handle for resuming the pressing handle 2 to its original position after pressed.

The air valve 3 is disposed in the main body 1 and controlled by the pressing handle 2 for opening the channel. Namely, the channel is closed by the air valve when the pressing handle is not pressed so that the high-pressure air coming from the air inlet 12 cannot flow out from the outlet 11. In contrast, the channel is opened by the air valve when the pressing handle is pressed so that the high-pressure air coming from the air inlet 12 can flow out from the outlet 11.

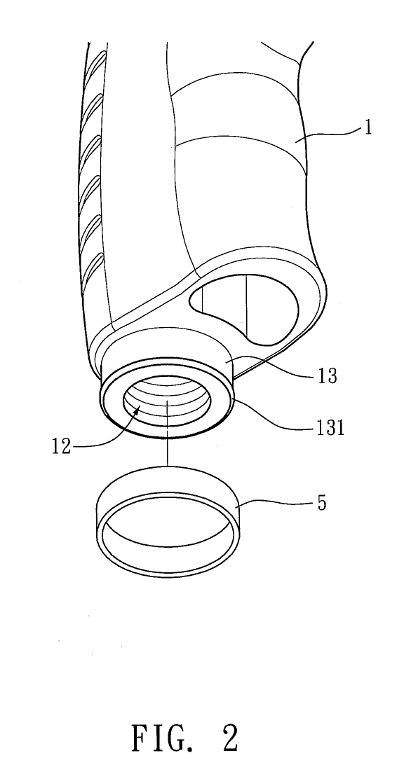

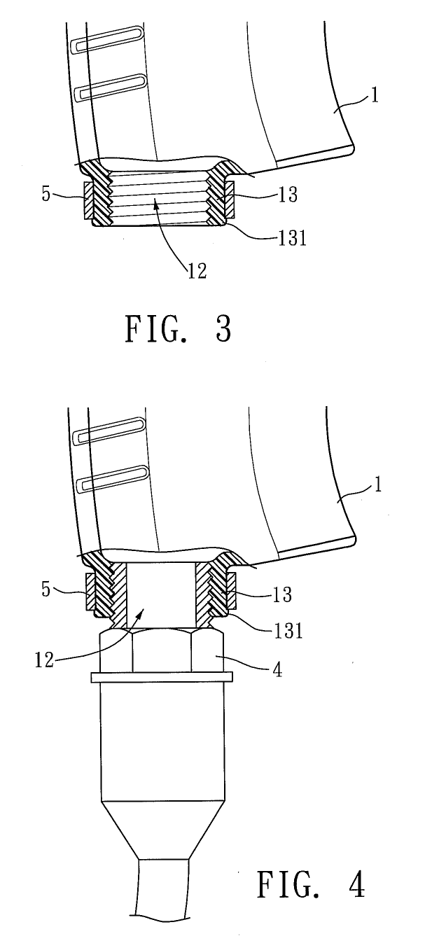

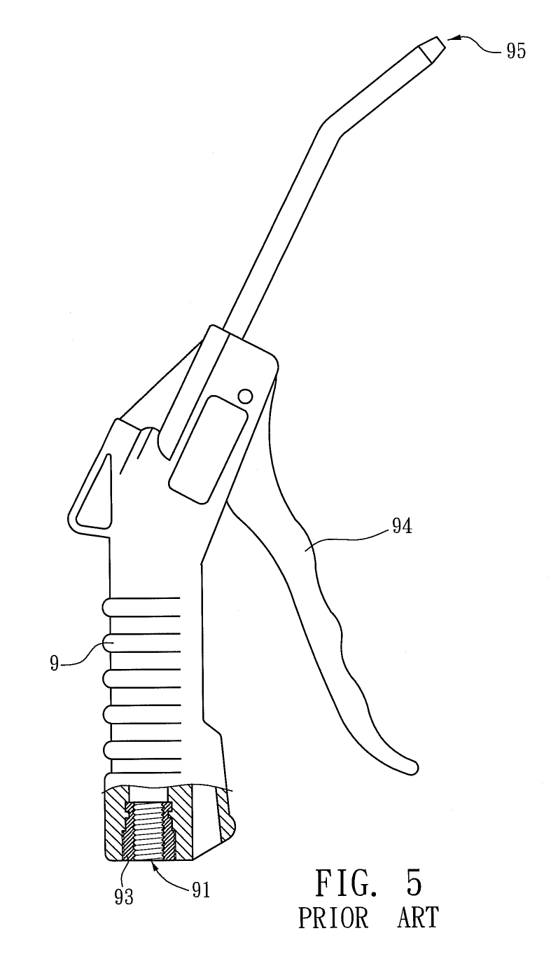

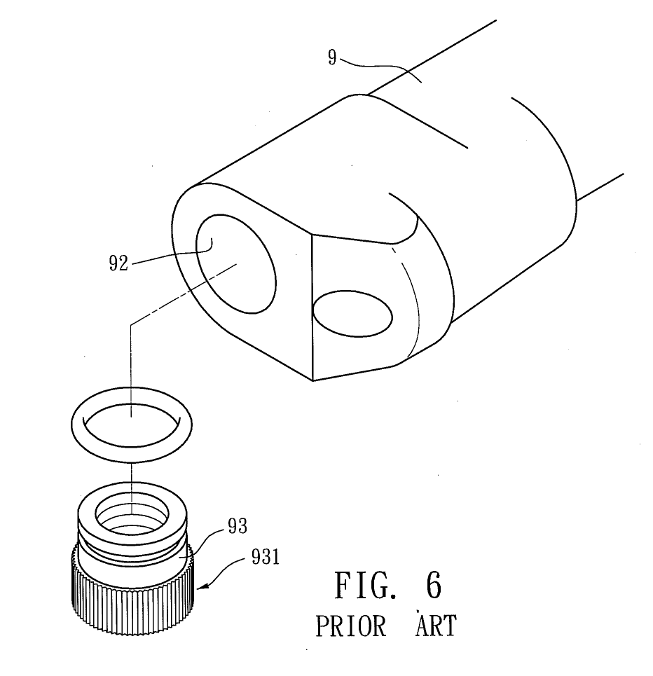

The main body 1 comprises a connection unit 13 at one end of the air inlet 12, and an air joint 4 can be secured by the connection unit 13. The main body 1 is connected to a high-pressure air source (such as an air compressor) through the air joint 4. As shown in FIGS. 2-3, the connection unit 13 extends outwards from one end of the air inlet 12. A metal ring 5 snares the peripheral of the connection unit 13 so that the metal ring 5 snares the peripheral of the connection unit 13 when the air joint 4 is secured in the connection unit 13.

As shown in FIGS. 2-3 again, the connection unit 13 of the present invention comprises a stop ring 131, protruding outwards, at the end in the extending direction. The stop ring 131 blocks the metal ring 5 at the bottom peripheral when the metal ring 5 snares the connection unit 13 to prevent the metal ring 5 from dropping out of the connection unit 13. The connection unit 13 is in a ring shape and extends outwards from the main body 1, and the metal ring 5 is in a ring shape as well and snares the peripheral of the connection unit 13 correspondingly.

As shown in FIG. 4, it is the cross section of the air joint 4 secured in the connection unit 13. Because the connection unit 13 is expanded to be a little bigger by the air joint 4 when the air joint 4 is secured, the metal ring 4 snares the connection unit 13 to have the effect of shape forming when the metal ring 5 snares the peripheral of the connection unit 13. Therefore, even though the air joint 4 expands the connection unit 13 a little bigger, the metal ring can maintain the structure strength of the connecting unit 13. Unlike the prior art, the connection unit 13 of the present invention is unbreakable when the air joint 4 is secured.

According to the explanation of the present invention, the present invention has an advantage on its structure with the simple metal ring 5 that can be implemented easily. The present invention can achieve the effect of strengthening the structure by using the metal ring 5 to snare the connection unit 13 extending from the main body 1. Compared with the conventional air duster gun, the present invention can lower the cost of components and simplify the manufacturing and assembling processes.

What is claimed is:

1. An improved air inlet structure of an air duster gun, comprising:
a main body, including a channel for flowing high-pressure air, an air outlet formed at the front end of the channel and an air inlet formed at the back end of the channel, and an air valve, and a pressing handle for controlling the air valve, which can resume its original position after being pressed, being pivotedly disposed at a side of the main body, characterized in that the main body comprises a connection unit for securing the air joint at one end of the air inlet, and the connection unit extending outwards from the end of the air inlet of the main body, wherein a metal ring snares a peripheral of the connection unit so that the air joint is snared by the metal ring when the air joint is snared by the peripheral of the connection unit.

2. The improved air inlet structure of an air duster gun according to claim 1, wherein the connection unit comprises a stop ring, protruding outwards, at one end in an extending direction to block the metal ring at a bottom peripheral and prevent the metal ring from dropping out of the connection unit when the metal ring snares the connection unit.

3. The improved air inlet structure of an air duster gun according to claim 1, wherein the connection unit is in a ring shape and extends outwards from the main body, and the metal ring is in a ring shape and snares a peripheral of the connection unit correspondingly.
